(19) United States
(12) Patent Application Publication
(10) Pub. No.: US 2017/0227411 A1
(43) Pub. Date: Aug. 10, 2017

(54) METHOD FOR OBSERVING AND/OR MONITORING STRAINS OCCURRING ON A SPORTS SHOE, AND A SPORTS SHOE FOR USE IN SUCH A METHOD

(71) Applicants: Andrea Drollinger, Engelsbrand (DE); Frank Drollinger, Engelsbrand (DE)

(72) Inventors: Andrea Drollinger, Engelsbrand (DE); Frank Drollinger, Engelsbrand (DE)

(21) Appl. No.: 15/040,185

(22) Filed: Feb. 10, 2016

(51) Int. Cl. G01L 5/16; A63B 24/00

(52) U.S. Cl. CPC G01L 5/167; A63B 24/0006

(57) ABSTRACT

A method for observing and/or monitoring strains which occur during sporting activities uses a sport shoe having downwardly extending engaging elements on a support which are pivotable about an axis perpendicular to a tread outsole. The method includes: observing how often the support is turned from its starting position within a time interval; forming a first variable which is a measure for the number of occurred turning movements of the support from the starting position observed within the time interval; and/or determining the pivot angle of the support and forming a second variable which is a measure for the sum of the pivot angles which occurred during the turning movements from the starting position which took place in said time interval, wherein the aforementioned steps are carried out by devices which are provided in or on the sport shoe; and displaying the first and/or second variables.

### CROSS-REFERENCE TO RELATED APPLICATIONS

None

### DESCRIPTION

Field of the Invention

The invention is based on a golf shoe comprising an outsole on which a support having downwardly extending engaging elements is attached, which support is pivotable about an axis perpendicular or approximately perpendicular to a tread of the outsole and has a starting position from which said support is pivotable against the action of a reset force which tries to turn the support back into the starting position thereof, wherein the engaging elements are arranged spaced apart from the axis. Such a golf shoe is known from WO 2004/037030 A1.

Background of the Invention

Golf shoes have a plastic sole which is more or less profiled and which has projecting engaging elements, in particular spikes, which penetrate more or less deeply into the turf or into the ground so as to increase the grip of the sole and to increase the golfer's stability. When driving the ball, especially when teeing-off, the player's upper body and hip should ideally turn about a stationary axis which should coincide with the player's spinal column. About this axis the player should first swing the golf club in upward direction, then back and in downward direction, forwards and through the position of the ball, and should finally continue the swinging movement in the direction of the envisaged target, while turning his upper body and hip, and terminate the movement in such a manner that the player's breast and pelvis are turned in the direction in which the golf ball flies. At the end of the swinging movement, the player's posture should be such that he looks in the direction of his target, with his breast and pelvis facing the target.

The golf shoe known from WO 2004/037030 A1 reduces the torsional strain on the body, the hip, the knee and ankle joints of the athlete in that the sports shoe, the spikes of which have dug into the ground or the turf, can turn with respect to the support at a certain angle without losing ground contact and thus stability.

In a refinement of the invention disclosed in WO 2004/037030 A1, the present invention relates to a method for observing and/or monitoring strains which occur during sporting activities on a sport shoe, in particular a golf shoe, which has an outsole on which a support having downwardly extending engaging elements is mounted, which support is pivotable about an axis perpendicular or approximately perpendicular to a tread of the outsole and has a starting position from which said support is pivotable against the action of a reset force which tries to turn the support back into the starting position thereof, wherein the engaging elements are arranged spaced apart from the axis. Furthermore, the method is characterized by the following steps:
observing, how often the support is turned from its starting position within a time interval;
forming a “first variable” which is a measure for the number of occurred turning movements of the support from the starting position observed within the time interval;
and/or determining a pivot angle of the support and forming a “second variable” which is a measure for the sum of the pivot angles which occurred during the turning movements from the starting position and which took place within said time interval; and
displaying the “first variable” and/or the “second variable”.

A sports shoe for use in a method according to the invention is the subject matter of the second independent claim. Advantageous refinements of the invention are the subject matter of the dependent claims.

### SUMMARY OF THE INVENTION

While playing with a sports shoe according to WO 2004/037030 A1 qualitatively suggests to the golfer that by using this sports shoe, compared to using a conventional shoe, the spikes of which are rigidly connected to the outsole of the sports shoe, playing is easier, less strenuous and less tiring, more painless and more accurate, the method according to the invention can provide the golfer with quantitative information as to what extent the strain caused by torsion of his/her body, hip, knee and ankle joints during a golf swing is reduced by using sports shoes according to WO 2004/037030 A1. Moreover, when the player has the “first variable” and/or the “second variable” displayed after one round on the golf course and compares them with displays obtained during earlier rounds on the same golf course, the golfer obtains an indication about his/her current play level. The smaller the displayed “first variable” and/or the displayed “second variable”, the better is his/her play level.

Each time when the support provided with the engaging elements is turned from its starting position, this is equivalent to avoiding torsional strains on the athlete, which torsional strains would be more intense if the athlete would have worn sports shoes having engaging elements (spikes) that are immovably fastened to the sole. The extent of the avoidance of torsional strain is clearly demonstrated to the athlete by the present invention. This can be implemented in that numerical values are displayed for the “first variable” and for the “second variable”. However, the “first variable” and the “second variable” can also be illustrated graphically, e.g. by a bar diagram.

The starting position of the support provided with the engaging elements is advantageously a position in which the support does not protrude on any side beyond the edge of the outsole of the sports shoe. Under the action of the reset force, the support returns automatically to this starting position when the athlete turns his body back into its normal position, at the latest when the athlete lifts his foot so that the engaging elements lose ground contact.

In order to generate the reset force, a spring is preferably used, in particular a spring that is preloaded in the starting position of the support. This is possible if the support, as is common for a golf shoe, can be turned from its starting position only in one direction and is prevented by a stopper from turning in the opposite direction. In its starting position, the support abuts against this stopper so that the stopper can absorb the preload of the spring.

The time interval for which the turning of the support is observed is freely selectable by the athlete. The time interval is preferably selected such that it comprises a complete round over the course when playing golf, or comprises a complete training session when training on the driving range.

The method steps specified in claim 1, except for displaying the “first variable” and/or the “second variable”, are carried out by means of devices which are provided in or on the sports shoe. For this purpose, the sports shoe has a position sensor that responds to a change of the position of the support, and an electrical circuit arrangement to which the position sensor transmits signals which depend on the positional change of the support. A “first variable”, which is a measure for the number of turning movements from the starting position observed by the position sensor within the selected time interval, can be formed from the transmitted signals. For this purpose it is sufficient to use as the position sensor a proximity switch which merely detects whether or not the support has been turned from its starting position. Alternatively or additionally, a “second variable”, which is a measure for the sum of the pivot angles at which the support has been turned from its starting position, can be formed in the circuit arrangement. In this case, the position sensor needs to be a displacement sensor or a rotary encoder which is able to detect to which extent the support is in each case turned from its starting position. The displacement sensor or rotatory encoder can be an incrementally operating sensor. Expediently, an output device is provided in the circuit arrangement in order to be able to display the “first variable” and/or “second variable”, which are/is formed in the circuit arrangement. This output device can be connected to a display device, e.g. an LCD display, in a wired or wireless manner. In the case of a wired connection, the display can be provided on the sports shoe or in the sports shoe, e.g. on the upper side of the sports shoe or on a cover sole of the sports shoe, or laterally on a lining of the sports shoe. In the case of a wireless connection to a display device, a computer, e.g. a laptop or a tablet computer, or a mobile phone, in particular a smartphone, or a smart watch can be used as a display device. Such apparatuses can be connected to the electrical circuit arrangement in which the “first variable” and/or the “second variable” are/is formed, or to the output device thereof, via a wireless interface, e.g. via a Bluetooth interface. Lastly, the sports shoe needs a power source for operating the position sensor, the electrical circuit arrangement including the output device, and optionally also for the display device.

The “first variable”, which is formed when carrying out the method according to the invention, is preferably proportional to the number of turning movements of the support from the starting position which took place within the selected time interval. The “second variable” formed when carrying out the method according to the invention is preferably proportional to the sum of the pivot angles which results from the turning movements from the starting position which took place within the selected time interval. In the simplest case, the proportionality factor is 1, this means that the “first variable” is the number of turning movements which took place from the starting position of the support; accordingly, the “second variable” is the sum of the pivot angles which results from the turning movements of the support from the starting position which took place within the selected time interval.

However, in an advantageous refinement of the invention, the proportionality factor is not selected to be 1. Rather, it is preferred to specify as the “first variable” a torque which corresponds approximately to the torsional strain avoided by using a sports shoe according to WO 2004/037030 A1. This is based on the assumption that on average, the avoided torsional strain on the athlete detected for each turning movement of the support provided with the engaging elements from the starting position is the same. As a measure for the torsional strain avoided overall within the selected time interval, the average torsional strain per turning movement of the support is multiplied by the number of turning movements which took place from the starting position. For the average torsional strain per turning movement of the support there are empiric values which depend on the weight of the golfer. The following formula is well suited for determining the average torsional strain avoided for each golf swing which causes a turning movement of the support from the starting position of the support:

T (Nm)=400 Nm+(G−50)×5 Nm.

G is the weight of the golfer in kilogram and T is the resulting avoidable average torsional strain in Newtonmeter (Nm) for each golf swing which causes a turning movement of the support carrying the engaging elements from its starting position. This formula provides useful values for body weights from 50 kg to 100 kg.

Determining the “second variable” can be approached accordingly by dividing the maximum possible pivot angle, e.g. 20°, into a number of identical angle segments, e.g. into four angle segments of in each case 5°, and developing a formula for each of them according to the aforementioned formula. Then, the torque values resulting from the turning movement of the support occurred within the selected time interval can be summed up in the electrical circuit arrangement so as to form the “second variable”. For this purpose, the circuit arrangement expediently includes an integrated circuit which has the required computing and storage capacity for the formation of the “first variable” and the “second variable”.

A sports shoe for use in the method according to the invention has an outsole on which a support having downwardly extending engaging elements is mounted, which support is pivotable about an axis perpendicular or approximately perpendicular to a tread of the outsole and has a starting position from which said support is pivotable against the action of a reset force which tries to turn the support back into the starting position thereof, wherein the engaging elements are arranged spaced apart from the axis. According to the invention, the shoe includes:
a position sensor which responds to a change of the position of the support and is arranged in the sports shoe;
an electrical circuit arrangement which is connected to the position sensor and arranged in the sports shoe, to which the position sensor transmits signals depending on the change of the position of the support, and in which a “first variable” is formed from the transmitted signals, said “first variable” being a measure for the number of turning movements of the support from a starting position observed by the position sensor within a selected time interval, and/or a “second variable” is formed, which is a measure for the sum of pivot angles at which the support was turned from its starting position within said time interval;
an output device which is an integral part of the circuit arrangement or is connected to the circuit arrangement and serves for outputting the “first variable” and/or the “second variable”; and
a power source.

The position sensor is preferably arranged in the outsole of the sports shoe. This is the best place for the sensor for responding to a change of the position of the support. In the simplest case, the position sensor is a proximity sensor which preferably responds to a metallic part of the support in an inductive or capacitive manner. A Hall sensor can also be used as a position sensor. If the position sensor is a displacement sensor, the “second variable” can be determined according to claim 1. Suitable displacement sensors are known to persons skilled in the art. They can also operate in an inductive or capacitive manner. Since in the case of the sports shoe according to the invention, the support having the engaging elements is mounted pivotably on the outsole, it principally also possible to use a rotary encoder for determining the “second variable”.

Depending on the type of position sensor used, the circuit arrangement connected to the position sensor determines from the signals transmitted from the position sensor either the “first variable”, which is a measure for the number of turning movements of the support which have been observed by the position sensor within a selected time interval, or the “second variable”, which is a measure for the sum of the pivot angles at which the support has been turned from the started position within the selected time interval, or the circuit arrangement forms both the “first variable” and the “second variable” from the signals transmitted from the position sensor. For this purpose, the circuit arrangement preferably includes at least one integrated circuit which has the computing and storage capacity required for forming the “first variable” and/or the “second variable”. The electrical circuit arrangement preferably also stores “first variables” and/or “second variables” which have been determined for earlier time intervals.

The output device, which is an integral part of the circuit arrangement or is connected to the circuit arrangement and serves for outputting the “first variable” and/or the “second variable” can be configured differently. It can include a display, in particular an LCD display, which is mounted on the upper side of the sports shoe or on a cover sole of the sports shoe or laterally on a lining of the sports shoe. In this case, the athlete can read the “first variable” and/or the “second variable” directly on the sports shoe. However, it is also possible to provide as the output device an interface which is suitable for transmitting or exchanging data and by means of which the electrical circuit arrangement can communicate with a computer, in particular with a laptop or a tablet computer, or with a mobile phone, in particular with a smartphone, or with a smart watch. A Bluetooth interface is particularly suitable as an interface. On the one hand, the “first variable” and the “second variable” can be queried and displayed via such an interface, and on the other hand, inputs into the electrical circuit arrangement, e.g., into a microprocessor or a microcontroller, which is integral part of the electrical circuit arrangement in the sports shoe, can be made, e.g. to switch on the electrical circuit arrangement in order to query the “first variable”, to query the “second variable”, to delete an input, to perform a reset, to query “first variables” or “second variables” obtained at an earlier time, to input start and end of the desired time interval, to change parameters of the specification for calculating the “first variable” or the “second variable”, wherein one of these parameters can be the weight of the athlete.

Lastly, the sports shoe also has a power source, in particular an electric battery or a rechargeable battery. The rechargeable battery can be charged, e.g., via a solar cell attached on the upper side of the sports shoe. Another possibility of power supply is to provide a mechanical-electrical converter, in particular such a converter which converts deformations of the shoe occurring during walking into electrical energy by means of the piezo-electric effect and stores it, e.g., in a capacitor. Such piezo-electric converters are known per se for other technical fields, e.g. for power supply to electrical circuits which are accommodated in tires of vehicles, see, e.g., DE 10 2010 038 136 A1, to which reference is made with regard to further details of the piezo-electric converter.

A sports shoe according to the invention can be used not only for golfing, but also for other sports in which swing movements are to be performed and absorbed, e.g. when playing baseball, tennis, field hockey and soccer. Soccer shoes have cleats which exert resistance against turning of the body of the soccer player, which resistance results in high strains on knee and ankle joints due to the intense physical engagement of soccer players. By mounting the cleats to the soccer shoes in a manner according to the invention so that they can be moved bidirectionally in a curved manner, the strains on the joints are reduced, and cruciate ligament ruptures, which are a typical result of excessive strain during turning movements, are avoided.

### BRIEF DESCRIPTION OF THE DRAWINGS

An exemplary embodiment illustrated in the accompanying drawings serves for further explanation of the invention.

FIG. 1 shows a golf shoe in an oblique view, wherein a portion of the shoe is shown in a transparent manner;

FIG. 2 shows the shoe from FIG. 1 in a view of the outsole;

FIG. 3 shows the enlarged detail A from FIG. 2;

FIG. 4 shows a top view of the rear part of the golf shoe; and

FIG. 5 shows a block diagram for an example of the circuit used in the golf shoe.

### DETAILED DESCRIPTION OF THE PREFERRED EMBODIMENTS

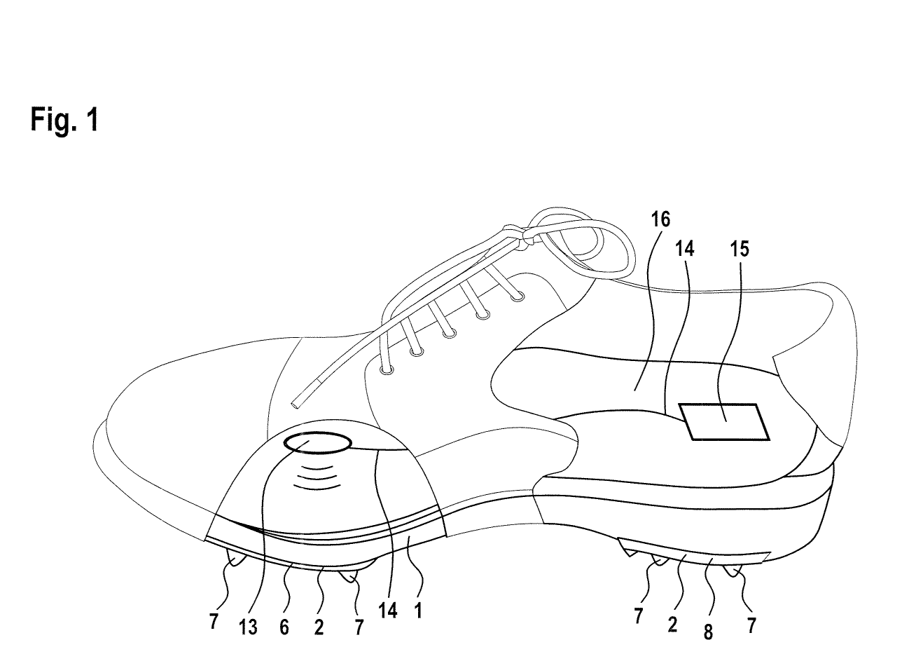

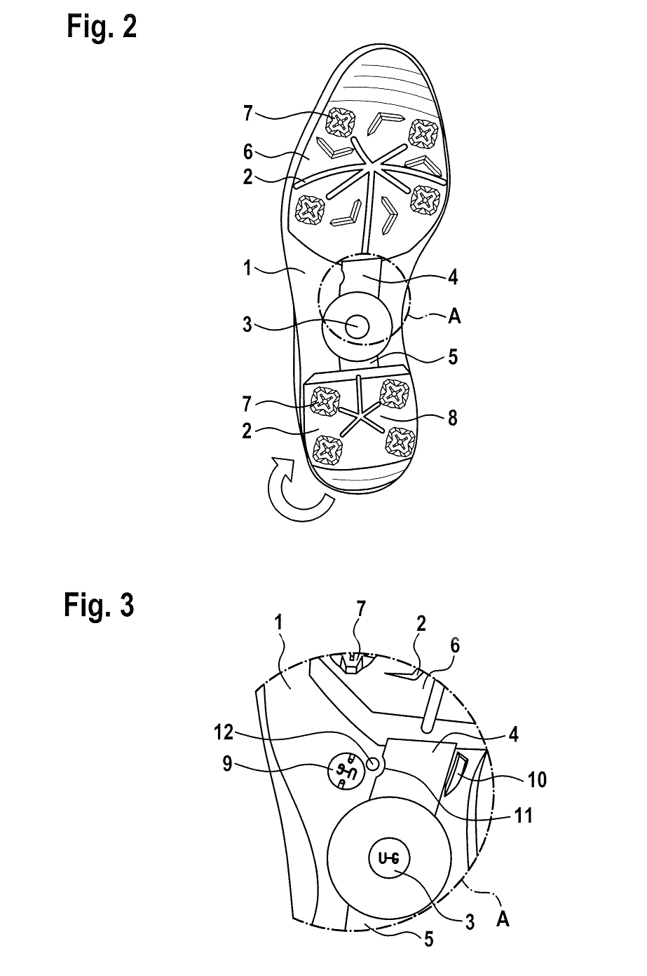

The golf shoe illustrated in the FIGS. 1 to 4 has an outsole 1, on the bottom side of which a two-armed support 2 is mounted to be pivotable about an axis 3. Two metallic arms 4 and 5, which are formed from a stable sheet metal, extend from the pivot axis 3. The first arm 4 extends towards the forefoot area of the golf shoe and is embedded into a plastic plate 6 which carries four downwardly facing engaging elements 7. The second arm 5 extends into the heel area of the golf shoe and is embedded in a plastic plate 8 which likewise has 4 downwardly facing engaging elements 7. The axis 3 is covered by a circular disk 8, below which a non-illustrated reset spring is arranged which, when the support 2 turns about its axis 3 from the starting position illustrated in FIG. 2 into a position as illustrated in FIG. 3, tries to turn the support 2 back into its starting position. The starting position of the support is fixed by a first stopper 9 against which the first arm 4 rests in the starting position under a preload of the reset spring. The angle at which the support 2 can be turned from its starting position is limited by a second stopper 10, which is situated opposite the first stopper 9 and against which the support 2 abuts with its first arm 4, as illustrated in FIG. 3.

The first stopper 9 has a cylindrical shank. Therefore, the first arm 4 has an arc-shaped recess 11 with which it abuts against the first stopper 9.

In the pivot range of the first arm 4, a position sensor 12 is provided in the outsole 1, which position sensor responds to the presence or absence of the metallic arm 4 below the position sensor 12 and is able in this manner to differentiate whether the support 2 is in its starting position (FIG. 2) or in a position turned from the starting position (FIG. 3).

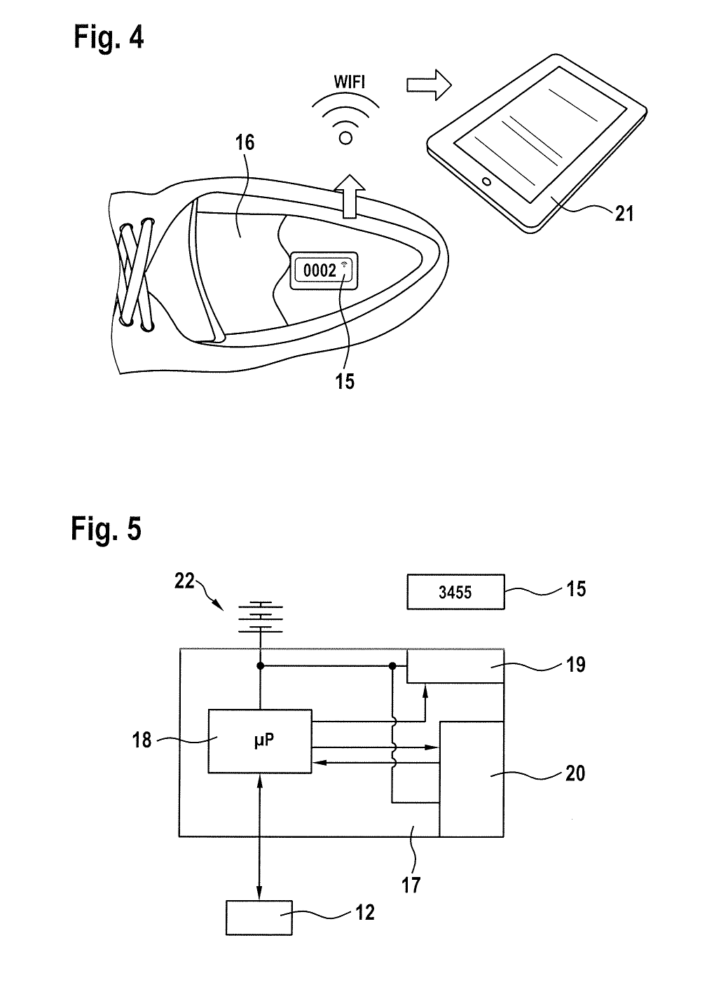

FIG. 1 shows schematically the position of circuit arrangement 13 which is arranged in the forefoot area of the golf shoe and connected to the position sensor 12 and to a display device 15 by an electric line 14 which is arranged in the heel area of the golf shoe and is illustrated in a top view in FIG. 4. The line 14 can run between the outsole 1 and a cover sole 16. As illustrated, the display is, e.g., an LCD display as illustrated in FIG. 4.

The circuit arrangement 13 can be arranged in a recess of the outsole 1 between the outsole and the cover sole 16 and is accessible after removing the cover sole 16.

FIG. 5 shows a simplified block diagram for an electrical circuit for carrying out the method. A circuit arrangement 17 includes as a dominating integral part a microprocessor 18 which receives input signals from the position sensor 12 and, depending on the type of position sensor, may form therefrom within a selectable time interval T a “first variable”, which is a measure for the number of turning movements of the support 2 from the starting position observed within the time interval, which turning movements are reported by the position sensor 12. If the position sensor 12 is a displacement sensor or a rotary encoder, the microprocessor 18 may determine from the signals of the position sensor 12 a “second variable” which is a measure for the sum of the pivot angles which occurred during the turning movements from the starting position (FIG. 2) which took place within the selected time interval T, and which are detected by the position sensor 12 and reported to the microprocessor 18.

The microprocessor 18 can output the “first variable” and/or the “second variable” in two different ways. One possibility is the output via the display 15 which is arranged in the golf shoe and for which a drive circuit 19 is provided in the circuit arrangement 17, which drive circuit is activated by the microprocessor 18. Another possibility is to output the “first variable” and/or the “second variable” on an external computer or on a mobile phone or on a smart watch. For this purpose, a bidirectional interface 20 is provided, in particular a Bluetooth interface, via which the microprocessor 18 can communicate, e.g., with a tablet computer 21, as illustrated in FIG. 4, or with a smartphone or with a smart watch. Via the tablet computer 2 or via a smartphone or via a smart watch, the circuit arrangement 17 can be controlled in the reversed direction in order to switch it on, to switch it off, to reset it, to query it, or to input or change parameters, e.g. the weight of the athlete, provided for the evaluation of the measuring results delivered from the position sensor 12.

A power source 22, which can be a battery, is provided for operating the circuit arrangement 17, the display 15, the driver circuit 19, the interface 20 and the position sensor 12.

The arrangement of the circuit arrangement 17 in the forefoot area of the golf shoe has, inter alia, the advantage that instead of a battery 22, e.g., a piezo-electric converter can also be provided there, which piezo-electric converter converts the deformations of the golf shoe occurring during walking into electric energy which can be stored in the circuit arrangement 17, e.g. in a capacitor, and can be used for power supply to the circuit arrangement 17 and to the connected components.

### REFERENCE LIST

1 outsole
2 support
3 axis
4 metallic arm
5 metallic arm
6 plastic plate
7 engaging element
8 plastic plate
9 stopper
10 stopper
11 circular recess
12 position sensor
13 circuit arrangement
14 electric line
15 display
16 cover sole
17 circuit arrangement
18 microprocessor
19 driver circuit
20 interface
21 tablet computer
22 power source
T time interval

What is claimed is:

1. A method for observing and/or monitoring strains which occur during sporting activities on a sport shoe and/or a golf shoe, which has an outsole on which a support having downwardly extending engaging elements is mounted, which support is pivotable about an axis perpendicular or approximately perpendicular to a tread of the outsole and has a starting position from which said support is pivotable against the action of a reset force which tries to turn the support back into the starting position thereof, wherein the engaging elements are arranged spaced apart from the axis, the method for observing and/or monitoring strains which occur during the sporting activities on the sport shoe comprises the steps of:
observing how often the support is turned from its starting position within a time interval;
forming a first variable which is a measure for the number of occurred turning movements of the support from the starting position observed within the time interval; and/or
determining the pivot angle of the support and forming a second variable which is a measure for the sum of the pivot angles which occurred during the turning movements from the starting position which took place in said time interval, wherein the aforementioned steps are carried out by devices which are provided in or on the sport shoe; and
displaying the first variable and/or the second variable.

2. The method according to claim 1, wherein the first variable is proportional to the number of turning movements of the support from the starting position which took place within the selected time interval.

3. The method according to claim 1, wherein the second variable is proportional to the sum of the pivot angles of the turning movements from the starting position which took place within the time interval.

4. The method according to claim 1, wherein the time interval is freely selectable.

5. The method according to claim 1, wherein a torque is displayed as the first variable and/or as the second variable.

6. The method according to claim 5, wherein the variable of the displayed torque is determined in such a manner that it is proportional to the number of turning movements of the support from the starting position and/or proportional to the sum of the pivot angles occurred at this number.

7. The method according to claim 6, wherein the variable of the displayed torque is determined in such a manner that it is also proportional to the weight of the person wearing the sports shoe.

8. The method according to claim 5, wherein the torque which is displayed corresponds approximately to the torsional strain on the athlete avoided due to the turning movements of the support from the starting position of the support within the selected time interval.

9. The method according to claim 1, including a spring which is used for generating the reset force.

10. The method according to claim 1, wherein the first variable and/or the second variable are/is displayed on a display device which is mounted on the upper side of the sports shoe or on the cover sole of the sports shoe or laterally on a lining of the sports shoe.

11. The method according to claim 1 wherein the first variable and/or the second variable are/is transmitted to and/or queried from a computer, a mobile computer, a mobile phone, a smartphone, and/or a smart watch.

12. The method according to claim 11, wherein the first variable and/or the second variable are transmitted in a wireless manner.

13. A sports shoe for performing the method according claim 1, the sports shoe comprising:
a position sensor which responds to a change of the position of the support and is arranged in the sports shoe;
an electrical circuit arrangement which is connected to the position sensor and arranged in the sports shoe, to which the position sensor transmits signals depending on the change of the position of the support, and in which a first variable is formed from the transmitted signals, said first variable being a measure for the number of turning movements of the support from a starting position observed by the position sensor within a selected time interval, and/or a second variable is formed, which is a measure for the sum of pivot angles at which the support was turned from its starting position within said time interval;
an output device which is an integral part of the circuit arrangement or is connected to the circuit arrangement and serves for outputting the first variable and/or the second variable; and
a power source.

14. The sports shoe according to claim 13, wherein the position sensor is arranged in the outsole of the sports shoe.

15. The sports shoe according to claim 13, wherein the output device includes a display and/or an LCD display, which is mounted on the upper side of the sports shoe, or on a cover sole of the sports shoe or laterally on a lining of the sports shoe.

16. The sports shoe according to claim 13, wherein the output device suitable for transmitting or exchanging data comprises an interface or a Bluetooth interface.

17. The sports shoe according to claim 13, wherein the position sensor is a proximity sensor.

18. The sports shoe according to claim 13, wherein the position sensor is a displacement sensor.

19. The sports shoe according to claim 13, wherein the power source is a mechanical-electrical converter arranged in the sports shoe, or a solar cell.

20. The sports shoe according to claim 19, wherein the converter converts deformations of the shoe occurring during walking into electrical energy by means of the piezo-electric effect.

21. The sports shoe according to claim 19, wherein the circuit arrangement includes a storage for the generated electrical energy.

22. The sports shoe according to claim 13, wherein the circuit arrangement includes a data storage.

23. The sports shoe according to claim 13, including a spring which is used for generating the reset force, wherein the spring is preloaded in the starting position of the support.

24. A method for observing and/or monitoring strains which occur during sporting activities on a sport shoe, wherein the method comprises the steps of:
providing the sports shoe having an outsole on which a support having downwardly extending engaging elements is mounted, which support is pivotable about an axis perpendicular or approximately perpendicular to a tread of the outsole and has a starting position from which said support is pivotable against the action of a reset force which tries to turn the support back into the starting position thereof, wherein the engaging elements are arranged spaced apart from the axis;
observing how often the support is turned from its starting position within a time interval;
forming a first variable which is a measure for the number of occurred turning movements of the support from the starting position observed within the time interval; and/or
determining the pivot angle of the support and forming a second variable which is a measure for the sum of the pivot angles which occurred during the turning movements from the starting position which took place in said time interval, wherein the aforementioned steps are carried out by devices which are provided in or on the sport shoe; and
displaying the first variable and/or the second variable.
